(19) United States
(12) Patent Application Publication
(10) Pub. No.: US 2020/0247687 A1
(43) Pub. Date: Aug. 6, 2020

(54) SYSTEM OF PURIFYING WATER, METHOD OF MAKING THE SAME, AND METHOD OF USING THE SAME

(71) Applicant: Purdue Research Foundation, West Lafayette, IN (US)

(72) Inventors: Ashreet Mishra, West Lafayette, IN (US); Agbai Nnanna, Odessa, TX (US)

(73) Assignee: Purdue Research Foundation, West Lafayette, IN (US)

(21) Appl. No.: 16/752,767

(22) Filed: Jan. 27, 2020

Related U.S. Application Data
(63) Continuation of application No. 62/800,931, filed on Feb. 4, 2019.

(51) Int. Cl. C02F 1/04; C02F 1/28; C02F 1/14; C02F 103/10

(52) U.S. Cl. CPC C02F 1/048; C02F 1/288; C02F 2103/10; C02F 1/14; C02F 1/283

(57) ABSTRACT

A system including an enclosure, wherein the enclosure includes a polyurethane foam. The polyurethane foam includes activated carbon. The polyurethane foam includes a plurality of perforations. The enclosure additionally includes an inlet, wherein the polyurethane foam is over the inlet. Moreover, the enclosure includes an outlet, wherein the outlet is over the polyurethane foam. Furthermore, the enclosure includes a heating element, wherein the heating element is configured to heat contents of the enclosure.

The present U.S. Patent Application is related to and claims the priority benefit of U.S. Provisional Patent Application Ser. No. 62/800,931, filed Feb. 4, 2019, the contents of which is hereby incorporated by reference in its entirety into this disclosure.

### TECHNICAL FIELD

This disclosure relates to a system of purifying water, method of making the same, and method of using the same.

### BACKGROUND

This section introduces aspects that may help facilitate a better understanding of the disclosure. Accordingly, these statements are to be read in this light and are not to be understood as admissions about what is or is not prior art.

Produced water is a byproduct that results from the oil refinery and extraction process. Handling of produced water is a major challenge in the oil refinery industry. Due to the contaminants it is deemed unusable for household and commercial use by the Environmental Protection Agency (EPA). Several different commercial produced water treatments are available, but they are expensive, do not often remove all traces of oil and other contaminants from the water, and can be energy intensive.

### SUMMARY

One aspect of the present disclosure relates to a system including an enclosure, wherein the enclosure includes a polyurethane foam. The polyurethane foam includes activated carbon. The polyurethane foam includes a plurality of perforations. The enclosure additionally includes an inlet, wherein the polyurethane foam is over the inlet. Moreover, the enclosure includes an outlet, wherein the outlet is over the polyurethane foam. Furthermore, the enclosure includes a heating element, wherein the heating element is configured to heat contents of the enclosure.

Another aspect of the present disclosure relates to a method of making a system, wherein the method includes providing a polyurethane foam. The method further includes perforating the polyurethane foam with a plurality of perforations, thereby forming a perforated polyurethane foam. Additionally, the method includes treating the perforated polyurethane foam with activated carbon nanofluid, thereby producing a treated perforated polyurethane foam. Furthermore, the method includes installing the treated perforated polyurethane foam into an enclosure. The treated perforated polyurethane foam is over an inlet of the enclosure. An outlet of the enclosure is over the treated polyurethane foam. Moreover, the method includes coupling a heating element to the enclosure. The heating element is configured to heat contents of the enclosure.

Still another aspect of the present disclosure relates to a method of using a system, wherein the method includes receiving a liquid in an enclosure through an inlet. The method additionally includes heating a polyurethane foam with a heat source, wherein the polyurethane foam is over the liquid, wherein the polyurethane foam is in the enclosure. Further, the method includes inducing the liquid to form a capillary force into a plurality of perforations of the polyurethane foam. Moreover, the method includes absorbing, by the polyurethane foam, crude oil substances from the liquid. The method additionally includes absorbing, by activated carbon, crude oil substances from the liquid, wherein the polyurethane foam comprises activated carbon. The method further includes channeling water vapor from the liquid through the plurality of perforations. Furthermore, the method includes collecting the water vapor into a distillation chamber. Next the method includes condensing the water vapor from the distillation chamber, thereby producing liquid water. The method also includes channeling the liquid water through an outlet of the enclosure.

### BRIEF DESCRIPTION OF DRAWINGS

One or more embodiments are illustrated by way of example, and not by limitation, in the figures of the accompanying drawings, wherein elements having the same reference numeral designations represent like elements throughout. It is emphasized that, in accordance with standard practice in the industry, various features may not be drawn to scale and are used for illustration purposes only. In fact, the dimensions of the various features in the drawings may be arbitrarily increased or reduced for clarity of discussion.

FIG. 1 illustrates a system for purifying produced water in accordance with one or more embodiments.

FIG. 2 illustrates a system for filtering produced water by polyurethane foam in accordance with one or more embodiments.

FIG. 3 illustrates a system conducting distillation experiment using simulated solar light in accordance with one or more embodiments.

FIG. 4 illustrates a system conducting distillation experiment using simulated natural solar light in accordance with one or more embodiments.

FIG. 5 illustrates initial steam generation results with activated carbon nanofluid and activated carbon foam.

FIG. 6 illustrates comparison of different volume % of oil used.

FIG. 7 illustrates produced water before and after filteration.

FIG. 8 illustrates distillate obtained with PU foam and activated carbon coated PU foam.

FIG. 9 illustrates water characteristics of obtained water compared with deionized water.

FIG. 10 illustrates distillation results in natural sunlight.

FIG. 11 illustrates comparison between natural and simulated solar light.

FIG. 12 illustrates effect of filter on evaporation performance.

FIG. 13 illustrates evaporation at a higher concentration of oil.

### DETAILED DESCRIPTION

For the purposes of promoting an understanding of the principles of the disclosure, reference will now be made to the embodiments illustrated in the drawings and specific language will be used to describe the same. It will nevertheless be understood that no limitation of the scope of the disclosure is thereby intended.

Various embodiments of the present application relate to a system and a process which removes almost all traces of oil in produced water. The system/process uses activated charcoal foam and subjects it to solar light. In some embodiments, the system/process uses activated carbon nano-powder immobilized on polyurethane foam to simultaneously absorb oil and total suspended solids. The heat generates steam at the surface of the foam. Tests conducted found that the distillate met all EPA standards for clean water from industrial sources and had a total organic carbon of 7.5 mg/L. This simple, clean, and inexpensive treatment process for produced water had higher recovery capacity compared to conventional methods in laboratory experiments.

Example 1: A system includes an enclosure, wherein the enclosure includes a polyurethane foam. The polyurethane foam includes activated carbon. The polyurethane foam includes a plurality of perforations. The enclosure additionally includes an inlet, wherein the polyurethane foam is over the inlet. Moreover, the enclosure includes an outlet, wherein the outlet is over the polyurethane foam. Furthermore, the enclosure includes a heating element, wherein the heating element is configured to heat contents of the enclosure.

Each perforation of the plurality of perforations has a diameter of approximately 0.001 meters. Additionally, a concentration of the plurality of perforations ranges from 200 perforations/meter² to 250 perforations/meter². The heating element includes a simulated solar light. A power output of the simulated solar light ranges from 800 W/m² to 1000 W/m². The heating element is concentrated solar light. In some embodiments, a power output of the concentrated solar light is greater than 3000 W/m².

In one or more embodiments, the enclosure further includes a distillation chamber, wherein the distillation chamber is in fluid communication with the outlet, wherein the distillation chamber is configured to channel liquid to the outlet. In at least one embodiment, the system further includes a pump, wherein the pump is connected to the outlet, and wherein the pump is configured to pump liquid out of the distillation chamber.

Example 2: A method of making a system, wherein the method includes providing a polyurethane foam. The method further includes perforating the polyurethane foam with a plurality of perforations, thereby forming a perforated polyurethane foam. Additionally, the method includes treating the perforated polyurethane foam with activated carbon nanofluid, thereby producing a treated perforated polyurethane foam. Furthermore, the method includes installing the treated perforated polyurethane foam into an enclosure. The treated perforated polyurethane foam is over an inlet of the enclosure. An outlet of the enclosure is over the treated polyurethane foam. Moreover, the method includes coupling a heating element to the enclosure. The heating element is configured to heat contents of the enclosure. In at least one embodiment, the method includes curing the treated perforated polyurethane foam at 50 degrees Celsius for a period of 5 hours.

Each perforation of the plurality of perforations has a diameter of approximately 0.001 meters. Additionally, a concentration of the plurality of perforations ranges from 200 perforations/meter² to 250 perforations/meter². The activated carbon nanofluid is 60% by volume.

In one or more embodiments, the enclosure further includes a distillation chamber, wherein the distillation chamber is in fluid communication with the outlet, wherein the distillation chamber is configured to channel liquid to the outlet. In at least one embodiment, the system further includes a pump, wherein the pump is connected to the outlet, and wherein the pump is configured to pump liquid out of the distillation chamber.

One of ordinary skill in the art would recognize that operations are added or removed from method, in one or more embodiments. One of ordinary skill in the art would also recognize that an order of operations in the above method is able to be changed, in some embodiments.

Example 3: A method of using a system, wherein the method includes receiving a liquid in an enclosure through an inlet. The method additionally includes heating a polyurethane foam with a heat source, wherein the polyurethane foam is over the liquid, wherein the polyurethane foam is in the enclosure. Further, the method includes inducing the liquid to form a capillary force into a plurality of perforations of the polyurethane foam. Moreover, the method includes absorbing, by the polyurethane foam, crude oil substances from the liquid. The method additionally includes absorbing, by activated carbon, crude oil substances from the liquid, wherein the polyurethane foam comprises activated carbon. The method further includes channeling water vapor from the liquid through the plurality of perforations. Furthermore, the method includes collecting the water vapor into a distillation chamber. Next the method includes condensing the water vapor from the distillation chamber, thereby producing liquid water. The method also includes channeling the liquid water through an outlet of the enclosure. The polyurethane foam is between the outlet and the inlet.

In at least one embodiment, the channeling the liquid water through the outlet of the enclosure includes using a pump to channel the liquid through the outlet of the enclosure. In one or more embodiments, each perforation of the plurality of perforations has a diameter of approximately 0.001 meters.

One of ordinary skill in the art would recognize that operations are added or removed from method, in one or more embodiments. One of ordinary skill in the art would also recognize that an order of operations in the above method is able to be changed, in some embodiments.

Example 4: A test was conducted where polyurethane foam was used as the purifying and distillate media which was perforated using a 0.001 m diameter plunger, Activated Carbon was immobilized on the Polyurethane Foam, SAE-5W 30 was the motor oil used, and Sodium Chloride (NaCl) was the salt source and tap water was the water source.

The produced water was prepared by magnetically stirring tap water, NaCl (25000 mg/L) and SAE-5W 30 (10%-25% by volume) for 60 minutes so as to create an oil water emulsion with dissolved impurities. The polyurethane foam was prepared by first washing it with water to remove any impurities and dried in an electrical oven for 5 hours at 50° C. Then activated carbon nanofluid 60% by volume was added to the foam uniformly and it was allowed to dry up in the electrical oven for 24 hours at 70° C.

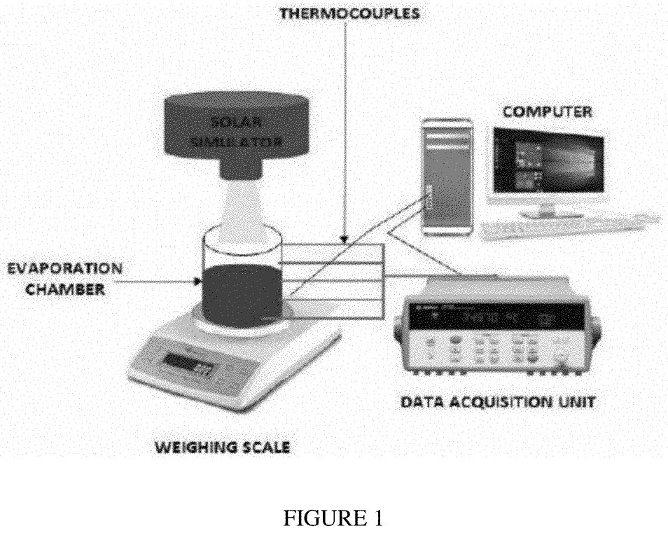

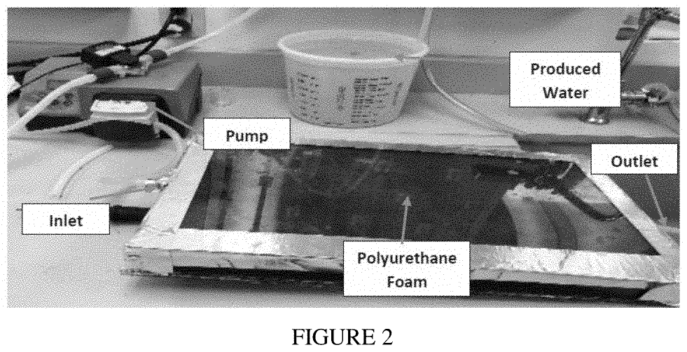

To test the feasibility of the setup for purifying Produced water initial experiments were done in an insulated beaker. The setup includes a quartz glass beaker (diameter=75 mm, height=150 mm, thickness=3 mm) which is placed on an electronic weighing scale (AND GX-8000) which records the weight loss of the sample in 1 minute intervals. It is connected to a computer which gives the output for the scale. The light source is a 500 W lamp which has uniform flux output. The intensity of the light on the top surface of the container was measured by a solar meter (TES 2000) and the value obtained was 0.7 kW/m². This was kept constant for all the experiments. It is depicted in FIG. 1.

Experiment for oil absorbance by polyurethane foam: The oil water mixture was passed through Polyurethane foam to check the amount of oil and dissolved solids that can be absorbed by the foam. The oil water mixture was put into the inlet and the outlet was obtained at the other end via the outlet. The absorbance values were measured by using UV-Vis spectroscope (Ocean Optics HR 4000) to observe the variation of absorbance. The change in absorbance is given by

$$\frac{Final absorbance - Initial absorbance}{initial absorbance} \times 100$$

where initial absorbance is the absorbance of the produced water and final absorbance is the absorbance obtained at the outlet and is measured once every 10 minutes to see the variation of absorbance.

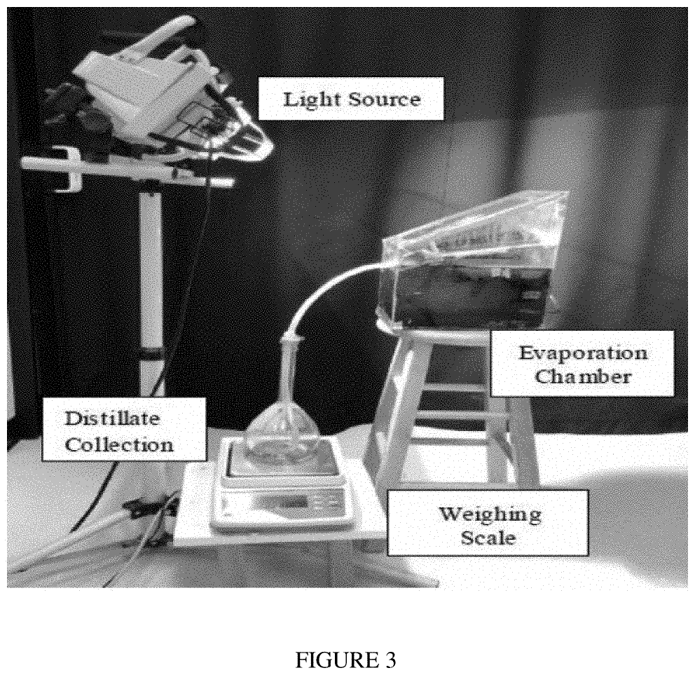

Distillation experiments using polyurethane foam under simulated solar light: The obtained filtrate from the polyurethane filter is then added to the evaporation chamber where it is irradiated with simulated solar light. The distillate is obtained and the temporal evolution is obtained from the weighing scale. The steam generated is condensed on the surfaces and then collected. The experimental setup is depicted in FIG. 3.

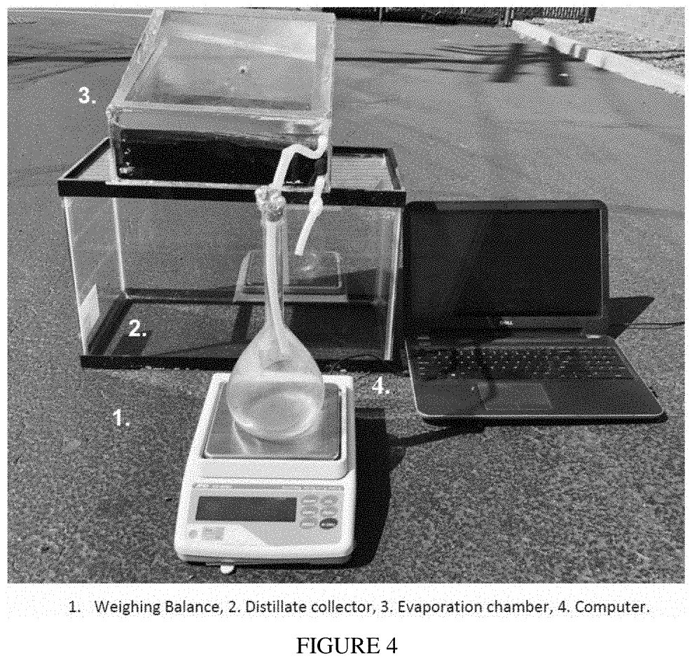

Distillation experiments using polyurethane foam under natural solar light: The same experiments that were performed using natural solar light and the evolution of the steam were monitored. This is depicted in FIG. 4. The present work has been compared with the existing methods like air diffusion method and centrifugal method. The oil and dissolved solids removal capabilities are tested by this method and compared.

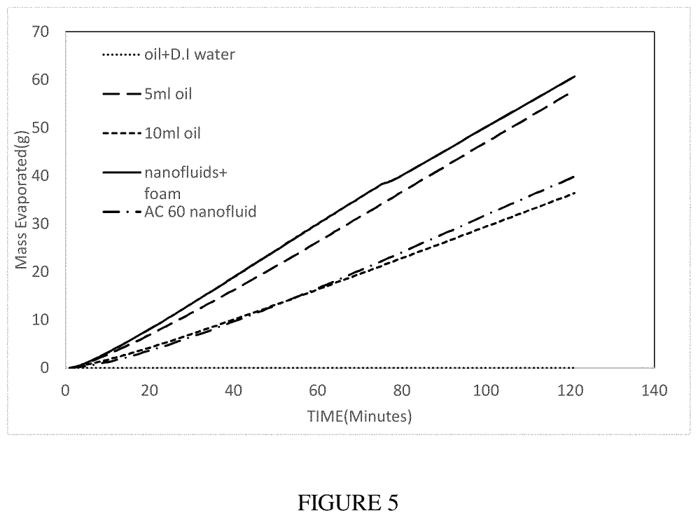

Initial test results: For the initial tests performed using activated carbon nanofluid and activated carbon foam using different concentrations of oil. These are shown in FIG. 5 and one can observe that the best result is obtained by the activated carbon coated polyurethane foam followed by the nanofluid. The experiments were almost comparable even when the concentration of the oil was increased to 25% by volume from 5% by volume. The activated carbon nanofluid did not show very convincing results for steam generation from the produced water. There was no steam generated when there was solar irradiation to the produced water suggesting that normal evaporation is not a viable option. There has to be some sort of surfactant or absorbant that has to be used to make the process viable.

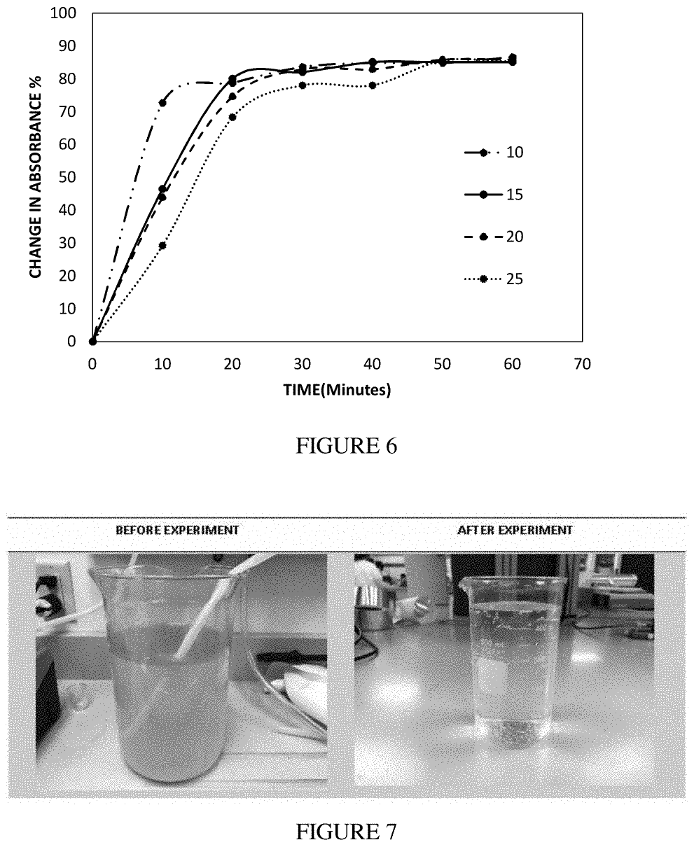

Oil absorbance by polyurethane foam: The oil absorbance of the polyurethane foam was observed for different concentration values of the oil from 10% to 25% by volume. We observe that the lower concentration of oil 10% is absorbed almost 80% in 15 minutes time whereas for the other higher concentration values it takes 25 minutes to reach the same amount of absorbance. The higher concentration values take longer time to reach the same filtered value as seen in FIG. 6. We see the input oil that enters the filter and the output in FIG. 7.

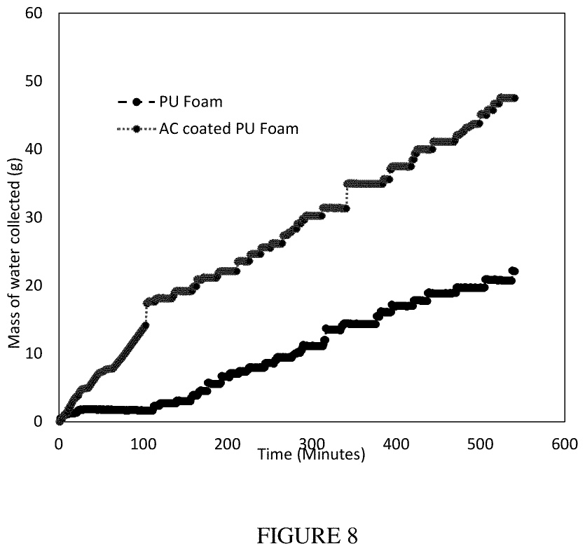

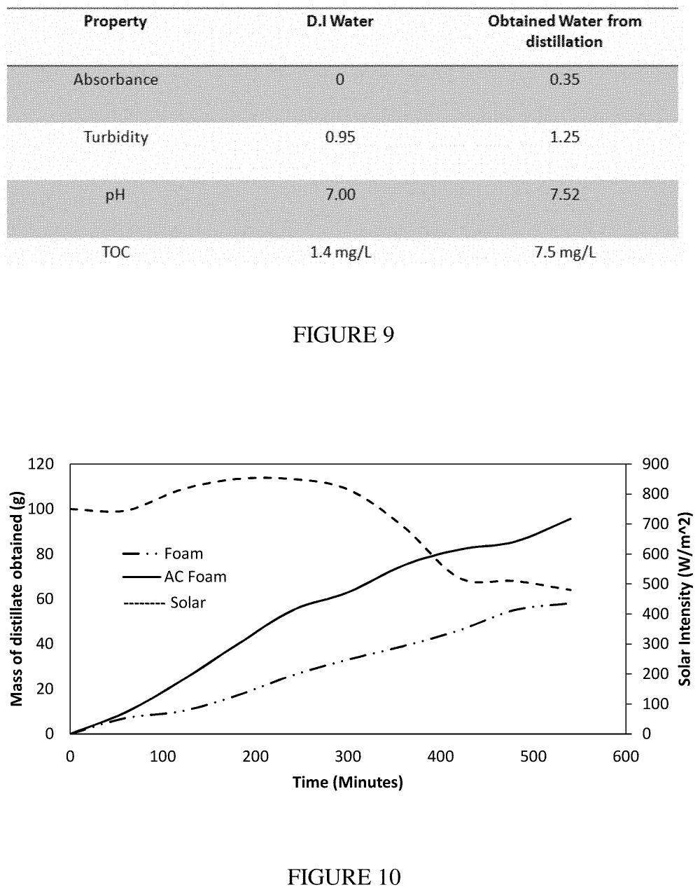

Distillation experiments using simulated light: The distillation was done with polyurethane foam and activated carbon foam. There was a higher output obtained with the activated carbon coated polyurethane foam than the normal polyurethane foam from FIG. 8. The water obtained characteristics were also mentioned in FIG. 9. We see that the water characteristics are almost similar to the deionized water, the TOC is a bit higher but under the US-EPA standards.

Distillation experiments using natural solar light: The distillation experiments were carried out in natural solar light as well so as to make sure that the ongoing process is applicable. So we see the activated carbon foam is better than the normal foam even under natural solar light, as illustrated in FIG. 10. The water characteristics obtained were similar as the simulated solar light.

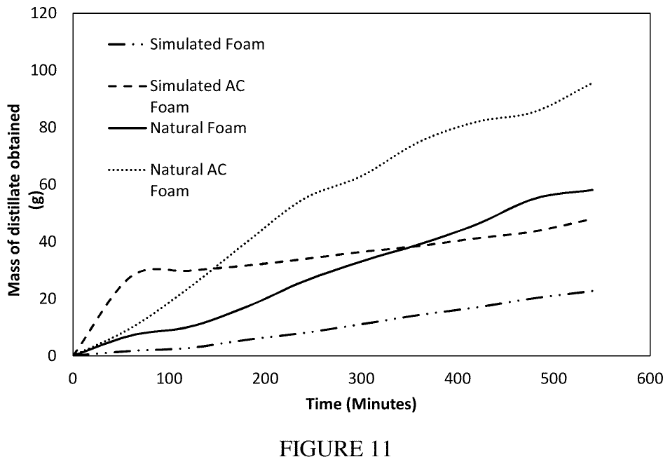

FIG. 11 illustrates the comparison between the simulated solar light and the natural solar light. One sees that there is a better result with natural solar light because when we use simulated solar light the light source is placed on one side of the setup and hence due to the heating effect two sides of the walls are not able to take part in the condensation process. But when it is used outside in natural solar light there is no such problem that occurs and all the surfaces of the walls can be used for condensation.

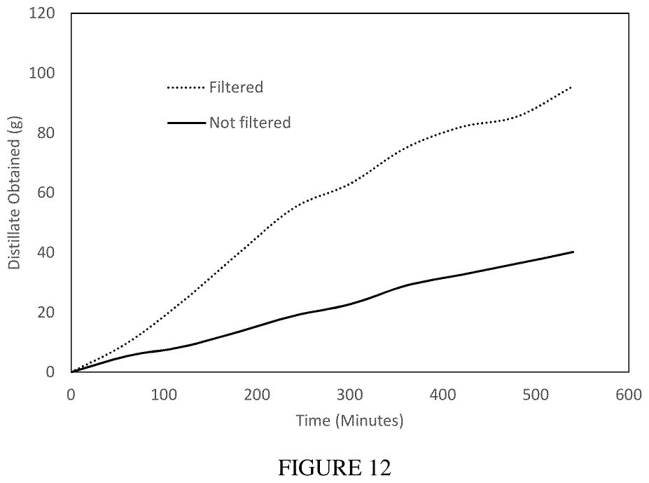

FIG. 12 illustrates that when we use produced water which has been pre-filtered by the PU foam there is a better evaporation performance than the one which has not been filtered previously. This happens because of the fact that when the water is pre filtered some of the oil is removed from it which does not let the evaporative foam clog its pores too soon which might hamper evaporation. So it is beneficial to enhance evaporation.

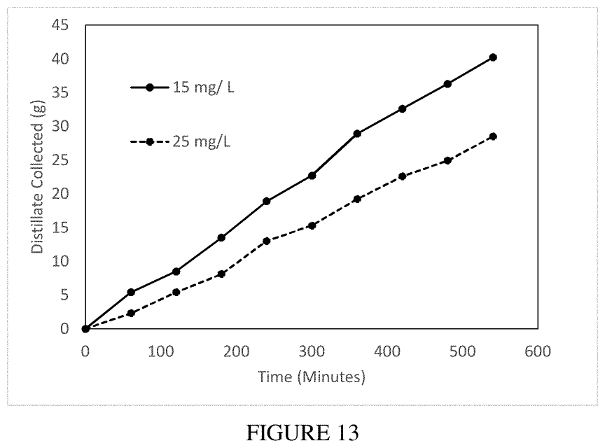

FIG. 13 illustrates us that the evaporation performance can work up-to 25 mg/L of oil. Although it decreases a bit from the original 15 mg/L but nevertheless there is still evaporation that is occurring here. So a high concentration of oil present can be used in the following setup without much complications.

By these initial results on the produced water treatment it is a viable option to obtain purified water at a very low cost option without any manual labor involved. This experiment for the first time uses polyurethane foam to simultaneously absorb oil and generate steam from the top surface of the foam because of the holed drilled in it. So this can be an interesting topic to carry out more research and develop the present method to upscale it and making it a viable method in the Texas basin for the large amounts of water being produced.

One of ordinary skill in the art would recognize that operations are added or removed from method, in one or more embodiments. One of ordinary skill in the art would also recognize that an order of operations in the above method is able to be changed, in some embodiments.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, design, machine, manufacture, and composition of matter, means, methods and steps described in the specification. As one of ordinary skill in the art will readily appreciate from the disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

1. A system comprising:
an enclosure, wherein the enclosure comprises:
a polyurethane foam, wherein the polyurethane foam comprises activated carbon, wherein the polyurethane foam comprises a plurality of perforations; and
an inlet, wherein the polyurethane foam is over the inlet; and
an outlet, wherein the outlet is over the polyurethane foam; and
a heating element, wherein the heating element is configured to heat contents of the enclosure.

2. The system of claim 1, wherein each perforation of the plurality of perforations has a diameter of approximately 0.001 meters.

3. The system of claim 1, wherein a concentration of the plurality of perforations ranges from 200 perforations/meter² to 250 perforations/meter².

4. The system of claim 1, wherein the heating element comprises a simulated solar light.

5. The system of claim 4, wherein a power output of the simulated solar light ranges from 800 W/m² to 1000 W/m².

6. The system of claim 1, wherein the heating element is concentrated solar light.

7. The system of claim 6, wherein a power output of the concentrated solar light is greater than 3000 W/m².

8. The system of claim 1, wherein the enclosure further comprises a distillation chamber, wherein the distillation chamber is in fluid communication with the outlet, wherein the distillation chamber is configured to channel liquid to the outlet.

9. The system of claim 8, further comprising a pump, wherein the pump is connected to the outlet, and wherein the pump is configured to pump liquid out of the distillation chamber.

10. A method of making a system, wherein the method comprises:
providing a polyurethane foam;
perforating the polyurethane foam with a plurality of perforations, thereby forming a perforated polyurethane foam;
treating the perforated polyurethane foam with activated carbon nanofluid, thereby producing a treated perforated polyurethane foam;
installing the treated perforated polyurethane foam into an enclosure, wherein the treated perforated polyurethane foam is over an inlet of the enclosure, and wherein an outlet of the enclosure is over the treated polyurethane foam; and
coupling a heating element to the enclosure, wherein the heating element is configured to heat contents of the enclosure.

11. The method of making the system of claim 10, wherein each perforation of the plurality of perforations has a diameter of approximately 0.001 meters.

12. The method of making the system of claim 10, wherein a concentration of the plurality of perforations ranges from 200 perforations/meter² to 250 perforations/meter².

13. The method of making the system of claim 10, further comprising curing the treated perforated polyurethane foam at 50 degrees Celsius for a period of 5 hours.

14. The method of making the system of claim 10, further comprising a distillation chamber, wherein the distillation chamber is in fluid communication with the outlet, wherein the distillation chamber is configured to channel liquid to the outlet.

15. The method of making the system of claim 14, further comprising a pump, wherein the pump is connected to the outlet, and wherein the pump is configured to pump liquid out of the distillation chamber.

16. The method of making the system of claim 10, wherein the activated carbon nanofluid is 60% by volume.

17. A method of using a system, wherein the method comprising:
receiving a liquid in an enclosure through an inlet;
heating a polyurethane foam with a heat source, wherein the polyurethane foam is over the liquid, wherein the polyurethane foam is in the enclosure;
inducing the liquid to form a capillary force into a plurality of perforations of the polyurethane foam;
absorbing, by the polyurethane foam, crude oil substances from the liquid;
absorbing, by activated carbon, crude oil substances from the liquid, wherein the polyurethane foam comprises activated carbon;
channeling water vapor from the liquid through the plurality of perforations;
collecting the water vapor into a distillation chamber;
condensing the water vapor from the distillation chamber, thereby producing liquid water; and
channeling the liquid water through an outlet of the enclosure.

18. The method of using the system of claim 17, wherein the channeling the liquid water through the outlet of the enclosure comprises:
using a pump to channel the liquid water through the outlet of the enclosure.

19. The method of using the system of claim 17, wherein each perforation of the plurality of perforations has a diameter of approximately 0.001 meters.

20. The method of using the system of claim 17, wherein the polyurethane foam is between the outlet and the inlet.
